(19) United States
(12) Patent Application Publication
(10) Pub. No.: US 2023/0377766 A1
(43) Pub. Date: Nov. 23, 2023

(54) COUPLING LITHIUM TO A SUBSTRATE

(71) Applicant: TAE Technologies, Inc., Foothill Ranch, CA (US)

(72) Inventors: Sergey Nikolayevich Vdovichev, Foothill Ranch, CA (US); Daniel Scott Marshall, Chandler, AZ (US); Anatoly Borisovich Muchnikov, Mission Viejo, CA (US)

(21) Appl. No.: 18/320,734

(22) Filed: May 19, 2023

Related U.S. Application Data
(60) Provisional application No. 63/343,924, filed on May 19, 2022.

(51) Int. Cl. G21G 4/02

(52) U.S. Cl. CPC G21G 4/02

(57) ABSTRACT

Neutron generation targets and methods for manufacturing neutron generation targets, e.g., for using in boron neutron capture therapy. One method includes pressing lithium foil to substrate with enough force, such that lithium deforms during the pressing operation and adheres to the substrate, thereby forming a thin lithium layer on the surface of the substrate.

### TECHNICAL FIELD

This specification relates generally to methods of coupling a lithium layer to a substrate and to manufacturing neutron-producing targets using said methods.

### BACKGROUND

Cancer is one of the leading causes of death in contemporary society. According to the Center for Disease Control, the death rate due to cancer in 2020 was 144 per 100,000 people. Locally invasive malignant tumors, such as brain cancer, cancers of head and neck, and cutaneous and extracutaneuous melanomas, are of particular concern as the effective means to treat or inhibit growth of those cancers is limited. For example, boron-neutron capture therapy, or BNCT, uses an accelerator-based neutron source to generate short-lived alpha-particles from boron-10 accumulated in the patients' tumor tissues. These alpha-particles selectively kill tumor cells while avoiding any damage to healthy organs and tissues.

### SUMMARY

This specification describes, inter alia, a lithium-containing neutron generation target, useful to produce a beam of neutrons for bombarding a boron-containing compound in a boron-neutron capture therapy (“BNCT”) of cancer. The present innovation is based, at least in part, on the realization that application of mechanical forces to a thin solid lithium film deposited on the surface of a target's substrate creates a well-bonded lithium layer of desired thickness (e.g., 100 μm) on the substrate surface. In one example, prior to depositing the lithium film (or, alternatively, foil) to the substrate, the surface of the substrate is coated with an intermediate layer (e.g., pure Al layer) that promotes and facilities adhesion of the lithium film to the substrate. Advantageously, the methods of this disclosure take much less time and energy compared to the conventional technique of manufacturing a lithium-containing target, which includes evaporating and condensing lithium metal on the substrate surface to produce the target. Using the methods of this disclosure produces neutron-generating target having a clean lithium layer of desired thickness bonded to the substrate surface that may be obtained quickly, cheaply, and efficiently.

Unless otherwise defined, all technical and scientific terms used herein have the same meaning as commonly understood by one of ordinary skill in the art to which the present specification belongs. Methods and materials are described herein for use in the present application; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

Other features and advantages of the present application will be apparent from the following detailed description and figures, and from the claims.

### DESCRIPTION OF DRAWINGS

FIG. 1A is a high-level schematic diagram of an example neutron beam system.

FIG. 1B is a more detailed schematic diagram of the example neutron beam system.

FIG. 2 is a cross-sectional view of an example target assembly subsystem.

FIGS. 3A, 3B, and 3C are cross-sectional, front perspective, and rear perspective views of an example neutron generation target.

FIG. 4A is a flow chart of an example process for manufacturing a neutron generation target by applying mechanical force to a lithium foil positioned on top of a substrate.

FIG. 4B is a cross-sectional view of an example combination of a lithium foil and a substrate for assembly into a neutron generation target.

FIG. 4C is a flow chart of another example process for manufacturing a neutron generation target by preparing a substrate and a lithium foil, and then applying mechanical force to the lithium foil positioned on top of the substrate.

FIG. 5A is a flow chart of an example process for manufacturing a neutron generation target by applying mechanical force to a lithium foil positioned over an intermediate pre-layer on top of the substrate.

FIG. 5B is a cross-sectional view of an example combination of a lithium foil and a substrate having an intermediate pre-layer for assembly into a neutron generation target.

FIG. 5C is a cross-sectional view of an example neutron generation target prepared by pressing lithium foil onto a substrate having an intermediate pre-layer.

FIG. 5D is a flow chart of another example process for manufacturing a neutron generation target by preparing a substrate, an intermediate layer, and a lithium foil, and then applying mechanical force to the lithium foil positioned over the intermediate pre-layer on top of the substrate.

FIG. 6A is a flow chart of an example process for manufacturing a neutron generation target by applying mechanical force to a lithium foil positioned over a pre-layer of lithium on top of the substrate.

FIG. 6B is a cross-sectional view of an example combination of a lithium foil and a substrate having a pre-layer of lithium for assembly into a neutron generation target.

FIG. 6C is a cross-sectional view of an example neutron generation target prepared by pressing lithium foil onto a substrate having an intermediate pre-layer of lithium.

FIG. 6D is a flow chart of another example process for manufacturing a neutron generation target by preparing a substrate, a pre-layer of lithium, and a lithium foil, and then applying mechanical force to the lithium foil positioned over the pre-layer of lithium on top of the substrate.

In the drawings, like reference numbers denote like elements.

### DETAILED DESCRIPTION

The lithium coupling techniques described in this specification can be used in a variety of applications where it is desired to attach a lithium layer to a substrate, for example, by adhering the lithium layer to the substrate by mechanical forces. The lithium-coupled substrates can be used in both medical and non-medical applications. Suitable examples of non-medical applications include fusion reactors, scientific tools for nuclear physics research (e.g., Faraday cups to catch charged particles in a vacuum), industrial manufacturing processes, beam systems for the alteration of material properties (e.g., surface treatment and transmutation), beam systems for the irradiation of food, and non-medical imaging applications (e.g., cargo or container inspection). Suitable examples of medical applications include beam systems for pathogen destruction and medical sterilization, medical diagnostic systems, medical imaging systems, and radiation therapy systems (e.g., X-ray machines, Cobalt-60 machines, linear accelerators, proton beam machines, and neutron beam machines). One example of a medical application of the lithium-coupled substrates is as a neutron-generating target for boron neutron capture therapy (“BNCT”).

Generally, BNCT is a type of treatment of a variety of types of cancer, including the most difficult types. Examples of such cancers include liver cancer (including liver metastases), oral cancer, colon cancer, brain cancer such as glioblastoma, head and neck cancer, lung cancer, extensive squamous cell carcinoma, laryngeal cancer, and melanoma. BNCT is a technique that selectively aims to treat tumor cells while sparing the normal cells using a chemical compound containing non-radioactive isotope boron-10, which has a high propensity to capture low energy “thermal” neutrons. In this technique, a boron-containing compound is administered to a patient (e.g., by injecting a parenteral composition into a blood vessel of the patient), so that boron-10 selectively collects in tumor cells. Suitable examples of boron delivery agents that can be administered to cancer patients include boronated amino acids, boron nitride nanotubes, liposome and immunoliposomes carrying particles of boron, various boron-containing nanoparticles, boronated cyclic or acyclic peptides having affinity to cancer cells (e.g., boronated arginylglycylaspartic acid, “RGD,” or a cyclic version thereof), boronated compounds having affinity to receptors overexpressed in cancer cells, boronated sugars, and boronic acid. Generally, these compounds are capable of selectively accumulating within malignant tumors while avoiding healthy tissues (e.g., at least about 85 wt. %, at least about 90 wt. %, at least about 95 wt. %, or at least about 99 wt. % of the boron compound accumulates in the tumor tissue as opposed to the healthy tissues). For example, upon administration of the boron carrier compound, tumor concentration of boron can be obtained in the range of about 20-50 μg ¹⁰B/g tumor. The tumor concentration of boron can be determined by any means generally known for this purpose, e.g., imaging, calibration, and/or biopsy. Once a sufficient amount of boron-10 has collected within a tumor, the patient receives radiation in the form of a neutron beam at or near the tumor site.

Typically, to produce a neutron beam, a neutron generating material, such as lithium, is bombarded with protons or other charged particles of sufficient energy (e.g., energy above the Li⁷→Be⁷ reaction threshold of 1.88 MeV); the protons are generated in an ion accelerator from a beam of negative hydrogen ions, for example. The neutron-generating reaction may be described as follows, where p represents a proton and n represents a neutron:

Li⁷(3p,4n)+p=Be⁷(4p,3n)+n

The resulting neutron beam is moderated and focused on the patient, where the neutrons react with the boron-10 in the tumor cells to generate a short-range alpha particle (He⁴) that selectively kills the tumor cells:

B¹⁰(5p,5n)+n=Li⁷(3p,4n)+He⁴(2p,2n)

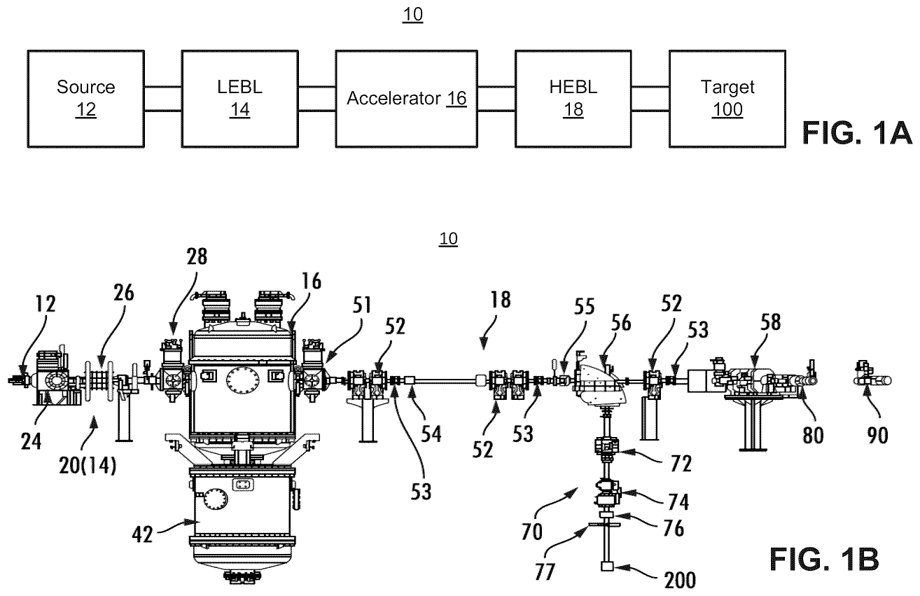

This specification describes a lithium-containing neutron generation target, useful to produce a beam of neutrons for bombarding a boron-containing compound administered to a patient during BNCT. FIG. 1A contains a schematic diagram of an example of a neutron beam system 10, which can be used to generate the neutrons for BNCT using a lithium-containing neutron generation target of the instant disclosure.

Shown in FIG. 1A, a beam system 10 includes a source of hydrogen ions 12, a low-energy beamline (“LEBL”) 14, an accelerator 16 coupled to the LEBL 14, and a high-energy beamline (“HEBL”) 16 extending from the accelerator 16 to a target 100. The LEBL 14 is configured to transport a negative hydrogen ion beam from the ion source 12 to an input of accelerator 16, which in turn is configured to produce a beam of protons by accelerating the beam of hydrogen ions transported by the LEBL 14. The HEBL 18 transfers the proton beam from an output of the accelerator 16 to the target 100.

Upon bombardment by protons of sufficient energy, the target 100 produces a beam of neutrons that is further directed to the tumor site in the patient body (not shown).

FIG. 1B is a more detailed schematic diagram of the neutron beam system 10 for use in boron neutron capture therapy (BNCT). Here, the source 12 is an ion source and the accelerator 16 is a tandem accelerator. The system 10 includes a pre-accelerator system 20, serving as a charged particle beam injector, a high voltage (HV) tandem accelerator 16 coupled to the pre-accelerator system 20, and an HEBL 18 extending from the tandem accelerator 16 to a neutron target assembly 200 housing a target (not shown).

The pre-accelerator system 20 is configured to transport the hydrogen ion beam from the ion source 12 to the input (e.g., an input aperture) of the tandem accelerator 16, and thus also acts as the LEBL 14. The tandem accelerator 16, which is powered by a high voltage power supply 42 coupled thereto, can produce a proton beam with an energy generally equal to twice the voltage applied to the accelerating electrodes positioned within the accelerator 16. The energy level of the proton beam can be achieved by accelerating the beam of negative hydrogen ions from the input of the accelerator 16 to the innermost high-potential electrode, stripping two electrons from each ion, and then accelerating the resulting protons downstream by the same applied voltage.

The HEBL 18 can transfer the proton beam from the output of the accelerator 16 to the target within the neutron target assembly 200 positioned at the end of a branch 70 of the beamline extending to a patient treatment room. The system 10 can be configured to direct the proton beam to any number of one or more targets and associated treatment areas. The illustrated HEBL 18 includes three branches 70, 80 and 90 that can extend to three different patient treatment rooms, where each branch can terminate in a target assembly 200 and downstream beam shaping apparatus (not shown). The HEBL 18 can include a pump chamber 51, quadrupole magnets 52 and 72 to prevent de-focusing of the beam, dipole or bending magnets 56 and 58 to steer the beam towards a corresponding target assembly, beam correctors 53, diagnostics such as current monitors 54 and 76, a fast beam position monitor 55 section, and a scanning magnet 74.

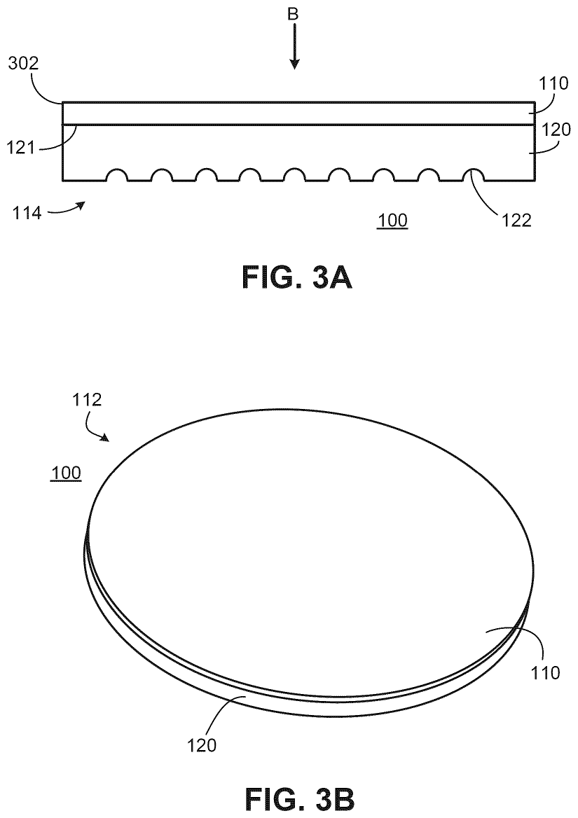

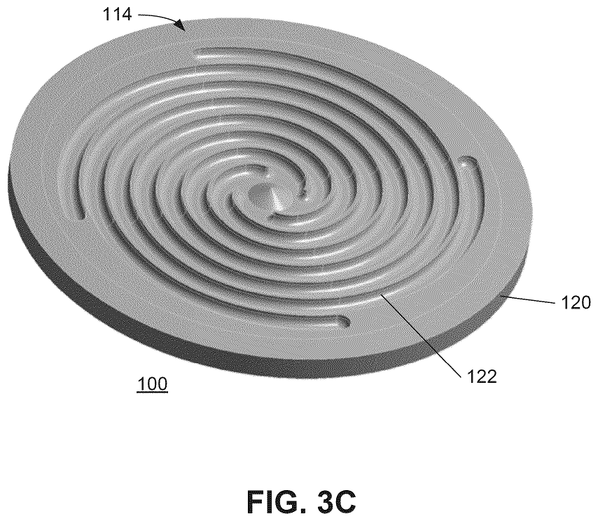

The design of the HEBL 18 depends on the configuration of the treatment facility (e.g., a single-story configuration of a treatment facility, a two-story configuration of a treatment facility, and the like). The proton beam can be delivered to target assembly 200 (e.g., positioned near a treatment room) with the use of bending magnets 56 and 58. Quadrupole magnets 72 can be included to then focus the proton beam to a certain size at the target. Then, the proton beam passes one or more scanning magnets 74, which provide movement of the proton beam onto the target surface in a desired pattern (e.g., spiral, curved, stepped in rows and columns, combinations thereof, and others). The proton beam movement can help achieve smooth and even time-averaged distribution of the proton beam on the lithium target, preventing overheating and making the neutron generation as uniform as possible within the lithium layer (e.g., lithium layer 110 shown in FIG. 3A).

The current monitor 76 measures beam current. The target assembly 200 can be physically separated from the HEBL volume with a gate valve 77. The main function of the gate valve is separation of the vacuum volume of the beamline from the target while loading the target and/or exchanging a used target for a new one.

In configurations, the beam is not be bent by 90 degrees by the bending magnet 56, it rather goes straight to the right of FIG. 1B, then enters the quadrupole magnets 52, which are located in the horizontal beamline. The beam could be subsequently bent by another bending magnet 58 to a needed angle, depending on the building and room configuration. Otherwise, the bending magnet 58 could be replaced with a Y-shaped magnet in order to split the beamline into two directions for two different treatment rooms located on the same floor.

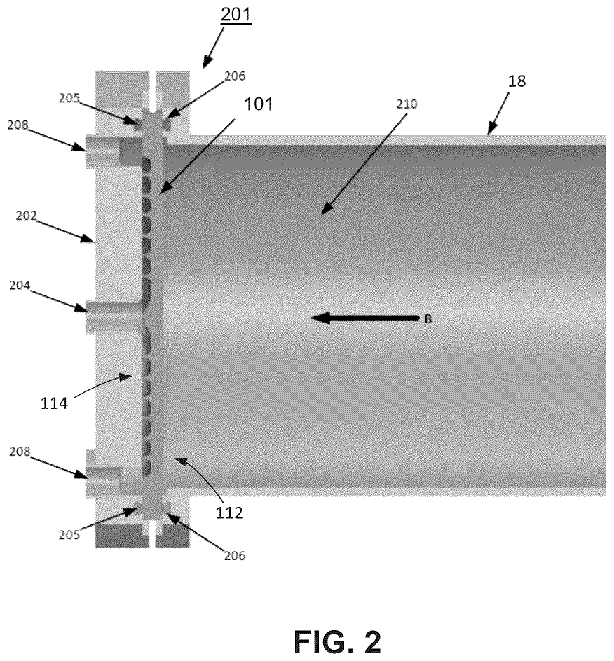

FIG. 2 is a cross-sectional view drawing depicting an example target assembly subsystem 201 that is suitable for use as the target assembly subsystem 200 of the neutron beam system 10 shown in FIGS. 1A and 1n FIG. 1B. A neutron generation target 101 is enclosed between a cap 202 and a vacuum or near vacuum interior region 210 of the HEBL 18. An arrow B shows the direction of the charged particle (e.g., proton) beam that first impacts the face of upstream side 112 of the target 101. Cooling of target 101 can be accomplished on the opposite downstream side 114 (from which the neutron beam exits the target 101). The cap 202 can be bolted to the HEBL 18, thus providing both a vacuum tight seal 206 between the target 101 and the vacuum region 210 of the HEBL 18, and a water-tight seal 205 between the target 101 and coolant inlet 204 and outlets 208.

### Examples of a Lithium Layer

FIG. 3A is a cross-sectional view depicting an example lithium-containing neutron generation target for BCNT. FIGS. 3A and 3B are perspective views of the upstream side 112 and a downstream side 114, respectively, of the target. The target includes a neutron generating layer of lithium 110. The lithium in this layer may be a naturally occurring lithium composed of two stable isotopes, Li⁶ and Li⁷. An amount of Li⁷ isotope in the naturally occurring lithium material may range from about 90 wt. % to about 99 wt. %, or from about 92 wt. % to about 98 wt. %. In some embodiments, the lithium in the layer 110 is enriched in Li⁷ and depleted in Li⁶, such that the lithium material contains about 99.9 wt. % or about 100 wt. % of Li⁷. The lithium in layer 110 may also contain other isotopes of lithium, such as Li³, Li⁴, Li⁸, Li¹¹, or Li¹², or any combination thereof with the Li⁶ and/or Li⁷ isotopes.

The lithium layer 110 may be configured as a planar neutron generation layer bonded to a surface 121 of a substrate 120. A proton beam propagating in direction B (e.g., from the tandem accelerator 16 along the HEBL 18 as shown in FIG. 1A) interacts with the layer 110 to produce neutrons that, in turn, pass through substrate 120 and exit from the downstream side 114 of the target. The thickness of the lithium layer 110 (e.g., the distance between the outer surface 302 of the layer 110 and the surface 121 of the substrate 120) can be selected depending on the energy of the protons propagating in the direction B. Table 1 illustrates the range (sometimes referred to as stopping range) of the average incident proton particle in naturally abundant lithium (approx. 92% lithium-7) for several proton energies. In the right column the variable “depth-to threshold” is listed, and represents the distance which an average proton travels inside of the material before it slows down to the threshold energy for a ⁷Li(p,n)⁷Be reaction (about 1.88 MeV). After a proton is slowed past this threshold energy it can no longer produce neutrons. For instance, for a proton energy of 2.50 mega electron-volts (MeV), the highly energetic proton enters the lithium material and then travels about 90 microns in lithium until it slows to the threshold energy. In this example, if the lithium thickness is less than 90 microns (μm), the neutron yield would be decreased and the lithium material is not utilized most efficiently. It is practically desirable to have a sufficiently thick lithium layer for the neutron-producing target, but not so thick that reduction of the proton's energy below the threshold dissipates excessive heat in the lithium or produces undesirable gamma-radiation. For example, for a 2.5 MeV proton beam, a 200 mm thick lithium layer may be undesirable dissipate excessive heat in the lithium layer.

TABLE 1
Lithium Range in Natural Abundance (⁷Li, about 92 wt. %)

| Proton | Range in | Depth to |
|---|---|---|
| Energy (MeV) | Lithium (μm) | Threshold (μm) |
| 3.00 | 319.77 | 176.27 |
| 2.75 | 274.89 | 131.39 |
| 2.50 | 233.11 | 89.61 |
| 2.25 | 194.48 | 50.98 |
| 2.00 | 159.08 | 15.58 |
| 1.88 | 143.50 | 0.00 |
| 1.80 | 133.12 | NA |

A suitable thickness of the lithium layer 110 is from about 15 μm to about 180 μm, from about 20 μm to about 150 μm, from about 40 μm to about 120 μm, from about 80 μm to about 120 μm, or from about 90 μm to about 100 μm. A suitable proton energy is from about 2 MeV to about 3 MeV, or from about 2.25 MeV to about 2.75 MeV. In a suitable pairing, the proton energy is about 2.5 MeV and the thickness of the lithium layer on the substrate surface is about 90 μm or about 100 μm.

### Examples of the Target Substrate

The substrate 120 can be configured for heat removal to dissipate the high energy level of the incident proton beam. As described above, the thickness of the lithium layer 110 is configured such that the thickness of the lithium layer allows protons to exit the layer 110 relatively soon or immediately after the proton energy drops below the threshold of the Li⁷(p,n)Be⁷ reaction for neutron formation (e.g., the threshold of 1.88 MeV for lithium-7). This avoids further energy dissipation in the layer 110, which is inefficient and leads to heating of the layer 110 without neutron production. Protons at about the threshold energy level penetrate to the substrate 120 and dissipate their remaining energy in the substrate 120 or partly in the substrate 120 and partly in one or more other components located downstream of the target.

The substrate 120 can be made of a material having a high thermal conductivity. Suitable values of the thermal conductivity of the substrate 120 include above 300 W×m⁻¹×K⁻¹, above 400 W×m⁻¹×K⁻¹, or above 500 W×m⁻¹×K⁻¹, or from about 400 W×m⁻¹×K⁻¹ to about 1000 W×m⁻¹×K⁻¹. The substrate material may be copper (Cu). Other suitable substrate materials include copper alloys, beryllium, chemical vapor deposited (CVD) diamond, or copper-diamond powder composites. The target can include one or more materials to inhibit blistering, such as a tantalum layer between the lithium layer 110 and the substrate 120. The protons that exit the lithium layer and deposit in the substrate 120 can generate a significant heat load in the substrate. For example, at an energy level of 2.5 MeV, exiting protons generate a heat load from about 20 kW to about 25 kW. The substrate therefore is actively cooled by a constant coolant flow. For example, the substrate 120 may contain spiral channels 122, as depicted in FIG. 3B, or channels of any other dimensions and configurations as desired. Suitable examples of coolants include water, ethanol, methanol, ethylene glycol, propylene glycol, or any mixtures thereof. By cooling the substrate, the substrate temperature during proton bombardment can be controlled so that it does not exceed the melting point of lithium (e.g., from about 180° C. to about 182° C.). In some examples, the substrate temperature during operation is cooled so as not to exceed 100° C. In certain examples, the target is a round target which is a plate with a diameter from about 4 inches to about 8 inches, such as about 6 inches. The thickness of the target substrate may be from about 6 mm to about 12 mm, from about 8 mm to about 12 mm, such as about 8 mm. In some examples, the substrate is about 50 times, about 60 times, about 70 times, about 80 times, about 90 times, or about 100 times or more thicker than the lithium layer in the target.

In some examples, a protective covering (e.g., a passivation region) can be positioned over the lithium layer 110 (e.g., in contact with the surface 302 of the lithium layer 110). Certain examples of the passivation materials, as well as their thickness and other characteristics, are described in PCT Publication WO 2022/212821 A1, which is incorporated herein by reference in its entirety. Example passivation materials include lithium fluoride, lithium sulfide, magnesium fluoride, carbon (C), diamond-like carbon, nanocrystalline diamond, a polymer, and combinations thereof.

### Examples of Methods of Adhering a Lithium Layer to a Substrate

While lithium is a valuable neutron-generating material, there are significant difficulties associated with depositing a clean layer of the required thickness of lithium on the target substrate. Lithium is a highly-reactive and corrosive metal that is difficult to handle in normal ambient conditions (e.g., air at room temperature such as found in general lab space, and the like). Lithium violently reacts with moisture, nitrogen and/or oxygen in atmospheric air and tarnishes and/or oxidizes rapidly. When exposed to atmosphere, lithium turns into a nitride (Li₃N), hydroxide (LiOH and LiOH—H₂O), oxide (Li₂O), or carbonate (Li₂CO₃, a result of a secondary reaction between LiOH and CO₂), or any combination of the foregoing. These reaction products can delaminate from the substrate in the form of a dust, and can prevent pure lithium from attaching to the material of the target substrate (e.g., copper). As used herein, the term “pure” refers to a material (e.g., a metal such as lithium, aluminum, copper, or gold) that is substantially free of contamination. For example, pure lithium is about 99 wt. % or more of lithium, such as about 99.5 wt. % or more of lithium.

Conventionally, to avoid contamination of a lithium layer by the products of its reaction with air and/or moisture, and to facilitate its attachment to the target substrate, a vacuum deposition technique was applied. However, this conventional method suffers from significant drawbacks. For example, evaporation of lithium onto the substrate takes a long time (e.g., up to 24 hours) and involves use of a heated vacuum evaporator. In addition, it is very hard to control where the evaporated gaseous lithium condenses in the vacuum chamber. The solid lithium metal therefore covers all surfaces of the chamber after condensation and cooling downtime, which requires additional time and cost to recover lithium that was not deposited on the target substrate. Moreover, using the vapor deposition technique, it is difficult to precisely control thickness of the lithium layer formed on the substrate surface, which is an important parameter in the neutron-generating process (as discussed above).

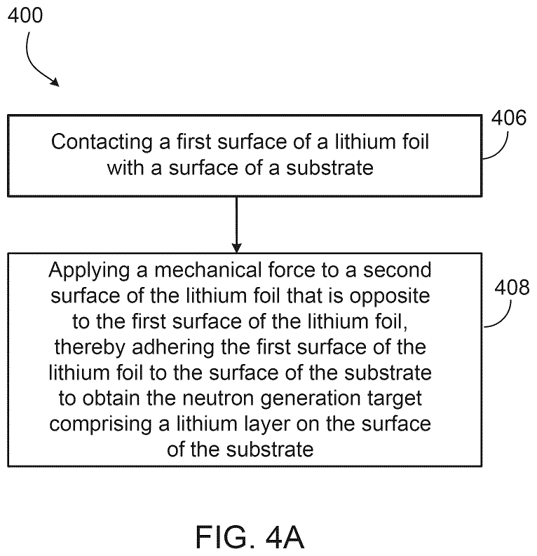

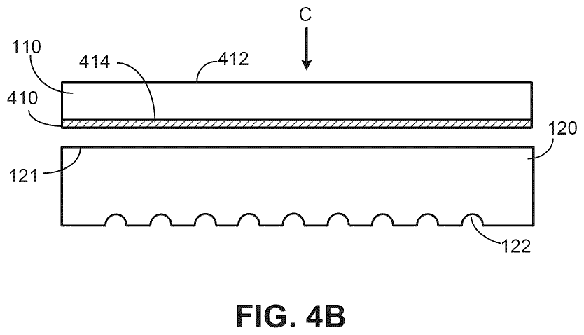

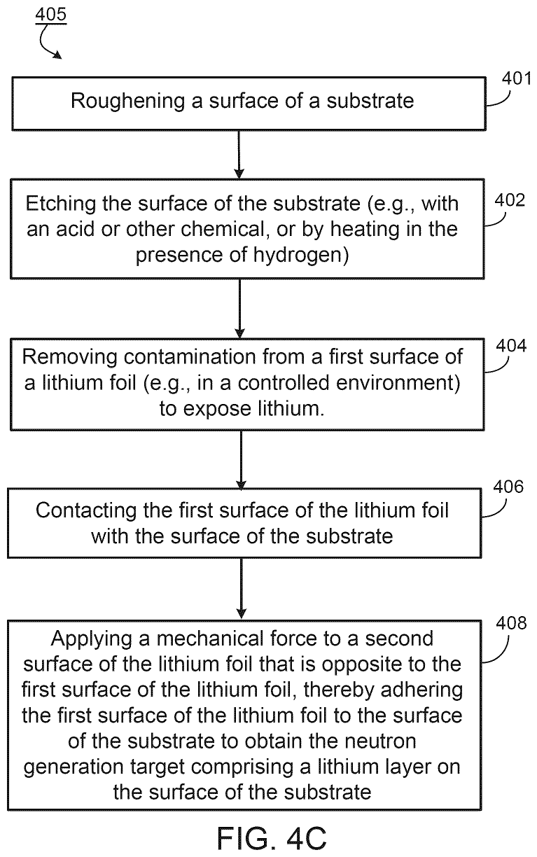

FIG. 4A is a flow-chart of an example process 400 for manufacturing a neutron generation target. The process involves contacting (406) a surface of a lithium foil with a surface of a substrate. In some examples, the contacting is continuous (e.g., an unbroken and uninterrupted contact is created between the first surface of the lithium foil and the surface of the substrate). In certain examples, a continuous contact is created between the surface of the lithium foil and the surface of the substrate such that 99% or more of the macroscopic area of the surface of the lithium foil is in unbroken and/or uninterrupted contact with a corresponding amount of the area of the surface of the substrate. This may be accomplished by rolling out the lithium foil of the desired thickness (e.g., 100 μm) on the surface of the substrate and pressing the lithium foil against the substrate to create the contact (e.g., a continuous contact) between the two surfaces.

In some examples, a free-standing foil, or a foil that is on a support (e.g., a plastic support) is created and applied to the substrate. Such a foil can be created by “calendaring” a volume of lithium, which typically involve crushing the lithium between two precision rollers to produce a foil with the desired thickness. This crushing process can be repeated multiple times until a foil having the desired thickness and width is achieved.

A mechanical force is applied (408) to the lithium foil to press it onto the substrate. The mechanical force may be applied, for example, using a hydraulic press or similar machinery. In some cases, the mechanical force is from about 1 megapascal (MPa) to about 3 MPa. In such cases, suitable values for the mechanical force include about 1 MPa, about 1.5 MPa, about 2 MPa, about 2.5 MPa, or about 3 MPa. In some examples, the mechanical force is at or above the compressive stress of lithium (e.g., about 2 MPa). In some cases, the foil can be applied by hand and pressure is applied by hand. Pressures in a range from 5 kilopascals (kPa) to 500 kPa can be sufficient (e.g., pressures from 5 kPa to 50 kPa, 5 kPa to 15 kPa). The steps 406 and 408 of the process 400 can be performed using two separate pieces of equipment. For example, in step 406, the desired contact between the two surfaces may be made by hand (e.g., in a glove box) or using a manual or an automated tool or instrument (e.g., a robotic arm), while in step 408, the contacting may be followed by using a second (separate) tool or instrument (e.g., a mechanical press) to apply the mechanical force to effect adhesion of lithium to the substrate. In some examples, the steps 406 and 408 of the process 400 are performed using the same tool or a piece of machinery. For example, a single instrument or a piece of equipment may be configured to effect contacting between the lithium foil and the substrate in step 406, and to apply the mechanical force to the lithium foil to effect adhesion. An example of such an instrument is a mechanical press equipped with a robotic arm.

FIG. 4C is a flow-chart of another example process 405 for manufacturing a neutron generation target. The process 405 includes roughening (401) the surface of the substrate. The process 405 also includes etching (402) the surface of the substrate. The etching (402) is carried out after roughening the surface. The etching may be carried out using an acid, such as an organic acid or an inorganic acid. Examples of organic acids usable in the etching process include acetic acid, pyruvic acid, citric acid, oxalic acid, succinic acid, and tartaric acid. Examples of usable inorganic acids include hydrochloric acid, nitric acid, hydrofluoric acid, phosphoric acid, and sulfuric acid. The etching may also be carried out by heating the surface of the substrate in the atmosphere of hydrogen or other chemically reactive gas, and/or by dry etching, which is also known as plasma etching in the semiconductor industry. In the latter process, the surface is cleaned by a chemical reaction between the etch species (such as charged ions of argon, hydrogen, oxygen, or fluorine gas, or the free radicals of these gases produced in the plasma) and the impurities on the surface of the substrate. Without being bound by any theory, it is believed that the plasma-activated atoms, radicals, and ions act like a sandblast to break down organic and inorganic contaminants, to form H₂O, CO, CO₂, and other volatile products that are easily removed from the surface.

The process (405) also includes removing (404) contamination from the first surface (e.g., cleaning or roughening the first surface) of the lithium foil to ensure that the exposed surface is sufficiently pure lithium. As the lithium metal is very reactive, the cleaning is carried out in the atmosphere of an inert gas, such as a noble gas (e.g., argon). For example, plasma-cleaning of the surface of the lithium foil can be done in a glove box, either at atmospheric pressure or under a vacuum. Such a decontamination in process 404 may be carried out by hot or cold plasma, as described above for the target substrate, but not to exceed the melting point of lithium.

The process 405 also includes steps 406 and 408, as described above with respect to FIG. 4A. Optionally, each step 401, 402, 404, 406, and 408 of the process 405 is performed using a separate piece of equipment. For example, roughening the surface (401), etching the surface (402), and decontamination of lithium foil (404) may be performed using three different plasma torches. Contacting lithium with the substrate (406) can be carried out manually or by a robot arm, e.g., in a glove box, and application of mechanical force (408) can be carried out using a separate hydraulic press. Alternatively, any two or more of the steps 401, 402, 404, 406, and 408 of manufacturing process 405 are performed using the same tool or a piece of machinery. For example, a single piece of equipment can be configured and adapted to carry out all of the steps 401, 402, 404, 406, and 408.

FIG. 4B is a cross-sectional view depicting an example intermediate article formed during the contacting lithium step (406) of the manufacturing process 400 or 405 (referring to FIGS. 4A and 4C). In this step a contact is formed between a lithium foil 110 and a surface 121 of the substrate 120 (e.g., a contact is formed between a first surface 410 of a lithium foil 110 and a surface 121 of the substrate 120). A mechanical force is then applied in direction C, perpendicular to the surface 410 and the surface 121, to a second surface 412 of the lithium foil 110 (the second surface 412 is opposite to the first surface 410 of the lithium foil 110).

The first surface 410 of the lithium foil 110, prior to contacting with the surface of the substrate, may be contaminated with a thin layer 414 composed of the products of reaction of lithium metal with O₂, N₂, H₂O, or CO₂, such as Li₂O, LiOH, Li²CO₃, and Li³N, or any combination of the foregoing (the thin layer 414 may be at least partly removed from the surface 410 during the cleaning step (404), if such a step is carried out). While pure lithium metal easily adheres to the material of the substrate, the contamination of the surface of the lithium foil interferes with the lithium-substrate bonding.

The mechanical force applied in direction C to the second surface 412 at or about the compressive stress point can induce lithium shear deformation, forcing the pure lithium metal in the foil 110 to crack and break through the thin layer 414 composed of contaminating compounds (e.g., Li₂O, LiOH, or Li₂CO₃), thereby reaching and bonding with the surface 121 of the substrate 120, to form a neutron generation target composed of a lithium layer on the surface of the substrate 120.

Explosion bonding can be used, in some examples. For example, two metals can be placed together and force from a press plate is applied by detonating an explosive charge behind the press plate. The momentary application of force due to the detonation presses the two pieces together, bonding the two materials.

The mechanical force in direction C to the second surface 412 can be applied using a hydraulic press and/or a pressing die with a pushing rod. The pressing device (e.g., a die) can be specifically designed for lithium pressing. The surface of the die can be prepared (e.g., coated) before contact with lithium to allow for successful separation of the die from the lithium surface after the pressing is completed.

The mechanical force applied to the surface 412 of the lithium modifies the thickness of the lithium foil 110 so that the thickness of lithium foil 110 after pressing is less than (e.g., about 99%, about 95%, about 90%, or about 80% of) the thickness of lithium foil 110 before the pressing.

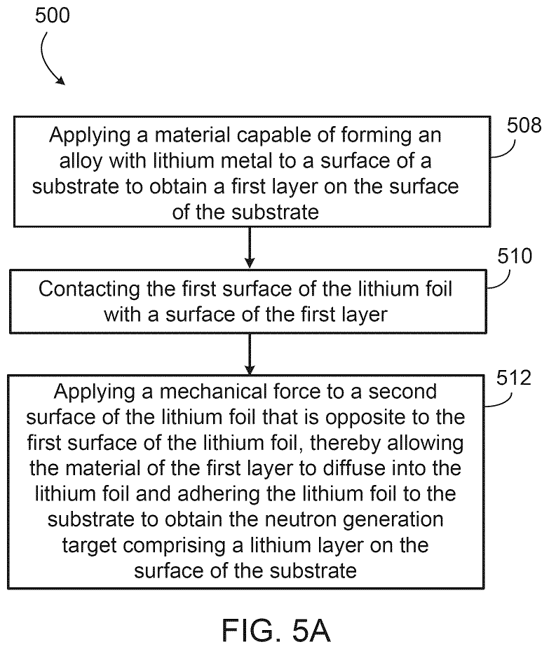

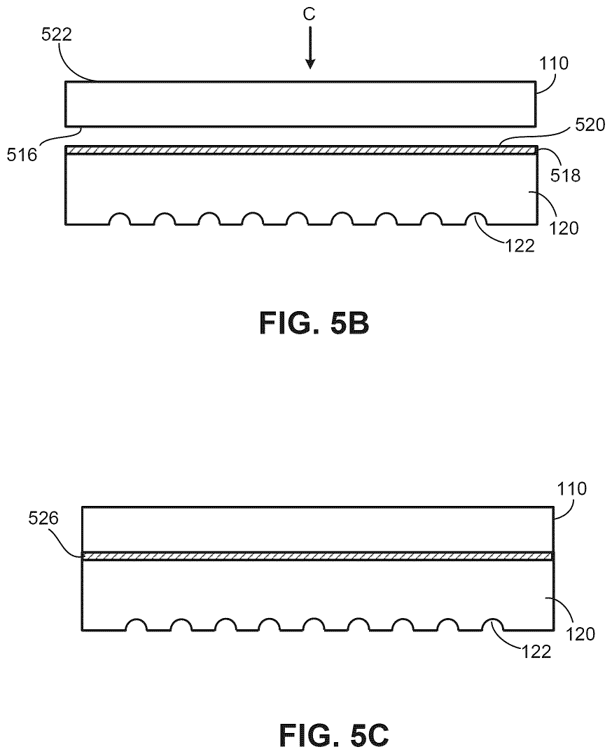

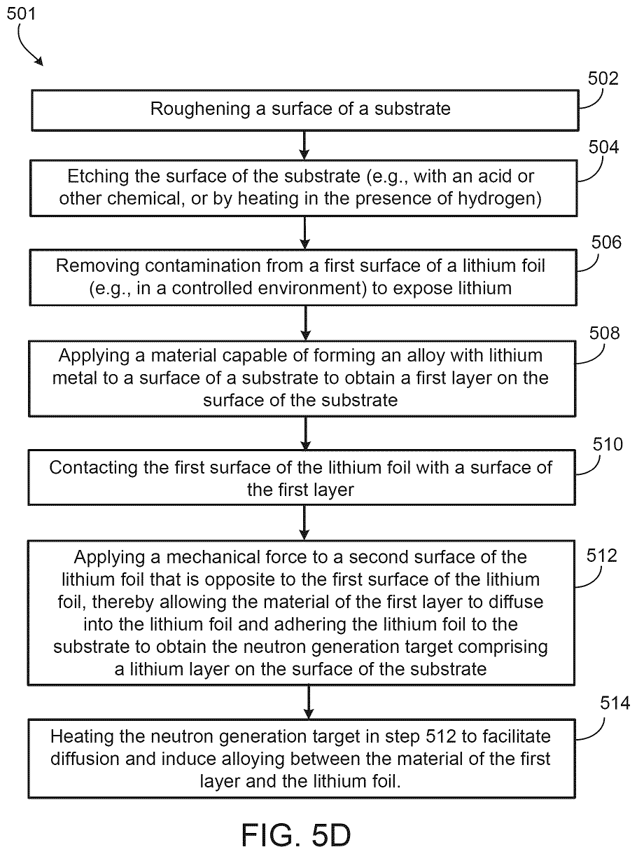

FIG. 5A is a flow-chart of another example of a process 500 for manufacturing a neutron generation target. The process creates (506) on a surface of a substrate a first layer of a material capable of forming an alloy with (and/or otherwise capable of chemically or physically adhering to) lithium metal. This first layer may be obtained by applying such a material to the surface of the substrate. The material may be applied in a vacuum chamber using a conventional vapor deposition technique. Or, the material may be applied by cold-plasma spraying the material on the surface of the substrate. Such spraying may be carried out in a glove box or otherwise in an air-free atmosphere, such as an inert gas (e.g., argon) atmosphere. The plasma spraying may be carried out at atmospheric pressure, or under a vacuum, depending on the material (e.g., Al or Pd), the desired thickness of the first layer, and other needs of the process.

Suitable examples of the materials of the first layer include aluminum (Al), silver (Ag), gold (Au), zinc (Zn), bismuth (Bi), and palladium (Pd), or any combination thereof. The material capable of forming an alloy with lithium metal can be pure aluminum (e.g., about 99 wt. % or more, about 99.5 wt. % or more aluminum), or pure gold (e.g., about 99 wt. % or more, about 99.5 wt. % or more gold), or pure palladium (e.g., about 99 wt. % or more, about 99.5 wt. % or more palladium), or an alloy of aluminum and gold, which can have about 50 wt. % or more, about 60 wt. % or more, about 70 wt. % or more, about 80 wt. % or more, or about 90 wt. % or more of aluminum, or which can have about 50 wt. % or more, about 60 wt. % or more, about 70 wt. % or more, about 80 wt. % or more, or about 90 wt. % or more of gold.

Other suitable examples of the materials of the first layer include chemically active adhesive materials (e.g., materials capable of reacting with and/or forming chemical bonds with the lithium surface). Examples of such materials include Si, SiO₂, SiO, Si₃N₄, C₃N₄, and other silicon and carbon-based materials suitable for coating a surface, or any mixtures or combinations thereof.

It is believed, for example, that when SiO₂ is deposited as a first layer 518 (FIG. 5B) on the surface of the substrate 120, the lithium foil 110 chemically adheres to the first layer 518 to form a layer 526 (FIG. 5C) by the following chemical reaction with the lithium metal:

Li+SiO₂=2LiO+Si

It is believed that when Si is deposited as a first layer 518 (FIG. 5B) on the surface of the substrate 120, the lithium foil 110 chemically adheres to the first layer to form a layer 526 (FIG. 5C) by any of the following chemical reactions ((i) or (ii)) with the lithium metal:
(i) Si+4Li=4Li₄Si (under about 200° C.)
(ii) 2Li+6Si=Li²Si₆ (when some Li atoms have temperature of about 600° C.)

It is believed that using chemically active adhesive materials as a first layer 518 facilitates physical adhesion of lithium foil 110 to the substrate 120.

Yet other suitable examples of materials for the first layer include materials capable of forming a buffer layer (or a protective layer) as a first layer 518 on the surface of the substrate 120. It is believed that such materials work as both an adhesive for the lithium layer 110 and a stop-layer to prevent interdiffusion (e.g., alloying) between Li and the material of the substrate (e.g., Cu). Examples of such materials include TiNSi, TiN, TiWN, Cr, Ti, Ta, TaN, Mo, V, LiF, CrLiO₂, CrLi₂O₄, CrLi₂O₂, as well as Li-based materials useful as electrode materials for Li-based batteries, or any mixtures or combinations thereof.

In some examples (e.g., when the first layer 518 works as a stop layer/adhesion layer), a combination (e.g., layering) of suitable materials are used. For example, a first layer may be a Cr/Ti double layer. It is believed that lithium metal is not soluble in chromium (e.g., there is substantially no or minimal diffusion of Li to Cr), and at the same time Cr has excellent adhesion to Cu (example of a material of the substrate 120). As such, a sub-layer of Cr may be deposed on the surface of Cu substrate, followed by another sub-layer of Ti on top of Cr to form the first layer 518. It is believed that such a combination first layer facilitates adhesion of the lithium layer 110 with the substrate 120 and at the same time prevents lithium metal from diffusion into the substrate (e.g., a substrate made from Cu or alloys thereof). Alternatively, a thin sub-layer of Ta, Mo, or V may be deposited (instead of Ti) on top of sub-layer of Cr.

In some examples, the first layer material is Pd, and the amount of Pd in the resultant lithium layer of the target is from about 0.5 wt. % to about 1 wt. %. In further examples, the first layer material is Al, and the amount of Al in the resultant lithium layer is less than about 10 wt. %. In yet other examples, the first layer material is Au, and the amount of Au in the resultant lithium layer is equal to or less than about 0.1 wt. %.

The thickness of the first layer 518 may be selected depending on the particular needs of the process. For example, thickness of the first layer may be from about 1 nm to about 5 nm, from about 2 nm to about 3 nm, from about 10 nm to about 20 nm, from about 10 nm to about 50 nm, from about 10 nm to about 100 nm, from about 0.01 μm to about 0.3 μm, from about 0.01 μm to about 0.2 μm, from about 0.05 μm to about 0.2 μm, from about 0.05 μm to about 0.2 μm, from about 0.01 μm to about 0.1 μm, or from about 0.5 μm to about 1 μm. In some embodiments, thickness of the first layer is about 0.01 μm, about 0.05 μm, about 0.1 μm, or about 0.2 μm. The thickness of the first layer may be selected based on the maximum amount of the first layer material that does not disrupt the neutron-generating function of the lithium layer. For example, an amount of the first layer material in the lithium layer after neutron generation target is formed in step 512 is from about 0.1 wt. % to about 10 wt. %, from about 0.1 wt. % to about 5 wt. %, from about 0.5 wt. % to about 2 wt. %, or from about 0.5 wt. % to about 1 wt. %. In some embodiments, the amount of the first layer material in the lithium layer of the neutron generation target is about 0.5 wt. %, about 1 wt. %, about 2 wt. %, about 5 wt. %, or about 10 wt. %.

The first layer material is preferably chosen such that the neutron yield of the target is no less than about 90%, about 80%, or about 75% of the neutron yield produced by a lithium target manufactured without any first layer material. It is believed that some of the metals constituting the first layer (such as Al, Au, or Pd) absorb the neutrons produced by the lithium target when the target is bombarded by protons. As such, the amount of the first layer material may be carefully chosen to allow efficient adherence of the lithium foil to the surface of the substrate, while also allowing sufficient neutron yield to reach the tumor site of the patient.

Referring to FIG. 5A, once the first layer is applied (508) to the surface of the substrate, the process 500 contacts (510) a surface of a lithium foil and the first layer (e.g., a surface of the first layer) on the substrate. The contacting may be continuous (e.g., an unbroken and uninterrupted contact is created between the first surface of the lithium foil and the surface of the first layer, as described above). The contacting step may be carried out in a manner similar to that of step 406 in process 400 as described herein.

Referring to FIG. 5A, as the last step in the process 500, a mechanical force may be applied (512) to the lithium foil to press it into the first layer on the substrate. This pressing may be carried out in a manner similar to that of step 408 in process 400 or 405.

FIG. 5B is a cross-sectional view of an example intermediate device formed during a combination of a lithium foil and a substrate made in manufacturing a neutron generation target. A contact (e.g., continuous contact) is formed between a first surface 516 of a lithium foil 110 and a surface 520 of a first layer 518. It is believed that during application of the mechanical force (512, FIG. 5A), the material of the first layer 518 diffuses (or dissolves) into the lithium foil 110 to form an alloy, with the result that the lithium foil 110 adheres to the substrate 120 to obtain a neutron generation target containing a lithium layer on the surface of the substrate. In some embodiments, the diffusion coefficient of the first layer material (e.g., Al, Au, or Pd) to lithium is from about 1×10⁻¹⁰ to about 1×10⁻⁹ cm²/s.

A cross-section of an example of a resulting target is schematically shown in FIG. 5C. Referring to FIG. 5C, a lithium layer 110 is bonded to the substrate 120 by the means of an alloy 526 of the first layer material and lithium. As described above, the proportion of the first layer material (such as Al) in the combined amount of lithium and the first layer material in the layers 110 and 526 typically ranges from about 0.1 wt. % to about 10 wt. %. This amount is selected based on the type of the first layer material, such that the neutron yield does not decrease by more than about 25% compared to neutron yield obtained from a target manufactured without the alloy 526.

FIG. 5D is a flow-chart of another example process 501 for manufacturing a neutron generation target. The process includes roughening (502) the surface of the substrate etching (504) the surface of the substrate, and removing (506) contamination from the first surface (e.g., cleaning or roughening the first surface) of the lithium foil to expose lithium. The steps 502, 504, and 506 of the process 501 can be carried out in a manner similar to the corresponding steps 401, 402, and 404, respectively, of the process 405 shown in FIG. 4C. Referring to FIG. 5D, the process 501 also includes steps 508, 510, and 512, which can be carried out in a manner similar to steps 508, 510, and 512 described for the process 500 described with reference to FIG. 5A. Optionally, the process 501 also includes heating (514) the neutron generation target made during step 512. This heating can be to a temperature below the melting point of lithium (e.g., to a temperature less than 180° C. The heating can have a variety of beneficial effects on the lithium adhesion to the first layer. For example, the heating can increase diffusion between the first layer and the lithium foil. Alternatively, or additionally, the heating can induce and/or increase alloying between the material of the first layer and the lithium foil. The target may be heated to about 80° C. or more, about 100° C. or more, about 110° C. or more, about 120° C. or more, about 130° C. or more, about 140° C. or more, about 150° C. or more, such as about 160° C. The target may be heated for an amount of time sufficient to induce and/or increase the diffusion process and/or induce and/or increase the alloying. For example, the target may be heated for about 1 sec or more, about 10 sec or more, about 30 sec or more, about 1 min or more, about 5 min or more, about 10 min or more, or about 30 min or more, such as up to an hour. The target may be heated for the duration of the application (512) of mechanical force.

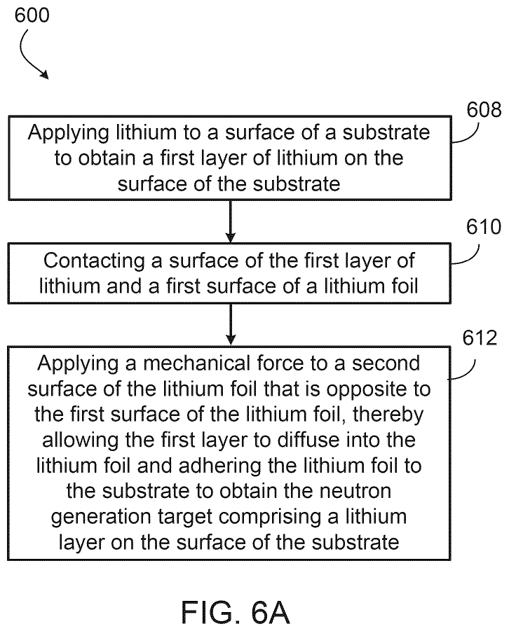

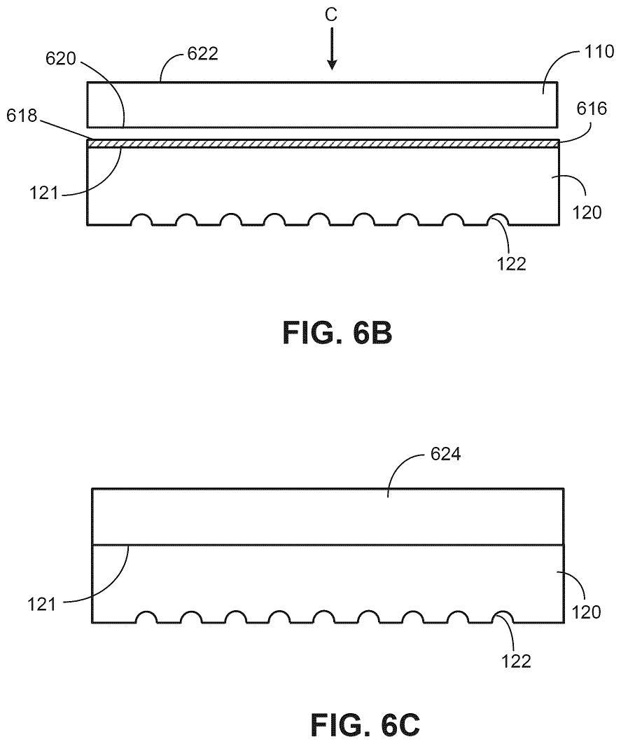

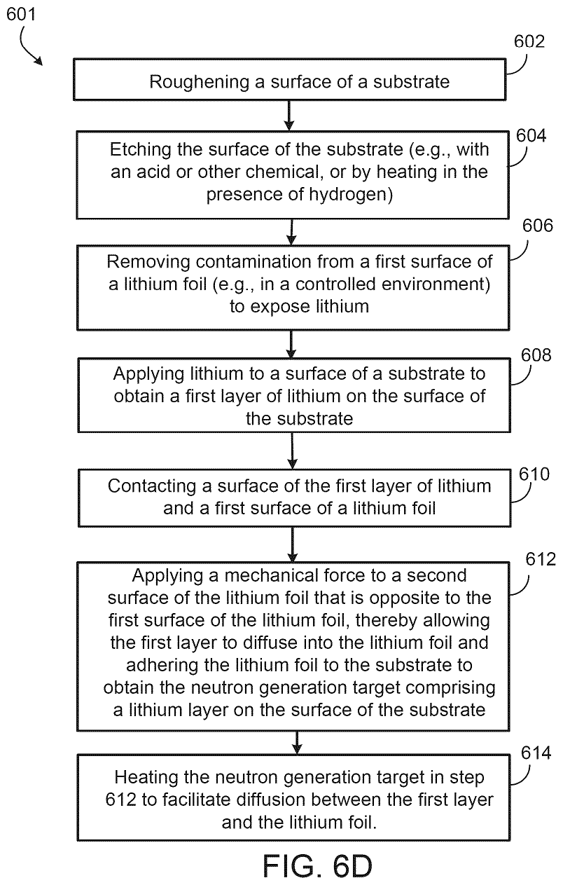

FIG. 6A is a flow-chart of an example process 600 for manufacturing a neutron generation target. The process creates (608) a first layer of lithium on a surface of a substrate. This first layer of lithium may be obtained by applying lithium to the surface of the substrate. The applying of the lithium to the substrate surface can be carried out in a manner similar to that described for the application of the first layer in step 508 of the process 500 of FIG. 5A. The thickness of the first layer of lithium in step 608 may be selected depending on the particular needs of the process. For example, thickness of the first layer of lithium may be from about 0.01 μm to about 0.3 μm, from about 0.01 μm to about 0.2 μm, from about 0.05 μm to about 0.2 μm, from about 0.05 μm to about 0.2 μm, or from about 0.01 μm to about 0.1 μm. In some embodiments, thickness of the first layer of lithium in step 608 is about 0.01 μm, about 0.05 μm, about 0.1 μm, or about 0.2 μm. The thickness of the first layer of lithium prepared in step 608 may be chosen to allow efficient adherence of the lithium foil to the surface of the substrate.

Once the first layer has been applied to the surface of the substrate, the process creates (610) a contact (e.g., a continuous contact) between one surface of a lithium foil and the first layer of lithium (e.g., a surface of the first layer of lithium) on the substrate. This step can be carried out in a manner similar to that described for step 406 of process 400 or step 510 of process 500.

Then, a mechanical force may be applied (612) to the lithium foil to press it into the first layer on the substrate. This step can be carried out in a manner similar to that of step 408 in process 400 or step 512 in process 500.

FIG. 6D is a flow-chart of another example process 601 for manufacturing a neutron generation target. The process 601 includes roughening (602) the surface of the substrate, etching (604) the surface of the substrate, and removing (606) contamination from the first surface (e.g., cleaning or roughening the first surface) of the lithium foil to expose lithium. These steps can be carried out in a manner similar to the corresponding steps 401, 402, and 404, respectively, of the process 400; or the steps 502, 504, and 506, respectively, of the process 500.

The process 601 also includes steps 608, 610, and 612, which can be carried out in a manner similar to steps 508, 510, and 512, respectively, described for processes 500 and 501 (with reference to FIGS. 5A and 5D). In some embodiments, the process 601 also includes a step that includes heating (614) the neutron generation target during the step of applying mechanical force (612) to facilitate diffusion between the lithium of the first layer and the lithium foil. This step can be carried out in a manner and with parameters similar to that of step 514 of process 500 described above.

FIG. 6B is a cross-sectional view of an example intermediate device formed during step 610 of the process 600 of FIG. 6A (a combination of a lithium foil and a substrate for manufacturing a neutron generation target). In this step, a contact is formed between a first surface 620 of a lithium foil 110 and a surface 618 of a first layer 616. It is believed that during application (612) of the mechanical force to the second surface 622 of the lithium foil 110, the lithium of the first layer 616 diffuses (or dissolves) into the lithium foil 110 to form a lithium layer, with the result being the adherence of the lithium foil 110 to the surface 121 of the substrate 120 to obtain the neutron generation target containing a lithium layer on the surface of the substrate.

A cross-section of an example resulting target is schematically shown in FIG. 6C. A lithium layer 624 composed of the lithium forming the first layer 618 and the lithium foil 110 adheres to the surface 121 of the substrate 120 due to the initial adherence and bonding of the first layer of lithium during deposition of this first lithium layer on the substrate. The process 601 may also include a step that includes heating (614) the neutron generation target while mechanical force is applied (612) to enhance adhesion (e.g., by enhancing diffusion) between the lithium of the first layer and the lithium foil to obtain a continuous layer of lithium on the surface of the substrate. As described above, the heating can be to a temperature below the melting point of lithium. This step can be carried out in a manner and with parameters similar to that of step 514 of process 500 described above.

In some examples, the substrate and/or lithium foil can be vibrated (e.g., ultrasonically vibrated) while the foil is pressed against the substrate (e.g., with or without a first layer). Vibrating the substrate and/or lithium foil can enhance adhesions between the substrate and the foil, e.g., by creating friction between the surfaces. The vibrating can be performed while the target is being heated. In some examples, the vibration has a frequency in a range from 1 kHz to 100 kHz (e.g., in a range from 5 kHz to 25 kHz).

While the foregoing methods involve roughening and etching the surface of the substrate to which the lithium layer (and, in some cases, a first layer of another material) is adhered, alternative or additional treatments of the substrate surface can be performed. For example, in some cases, the substrate surface can be cleaned by heating the surface. Sufficient heating of a copper surface, for example, can clean the copper surface by reducing surface oxides. Heating a copper substrate to about 300° C. or more while maintaining the substrate in an inert atmosphere (e.g., argon) can reduce copper oxide at the substrate surface to copper. Generally, any atmosphere devoid of the element to eliminate (e.g., oxygen in the form of copper oxide) can serve as a reducing atmosphere. In addition to argon, other possible gases suitable for reducing surface oxides are neon, helium, krypton, xenon, and N₂. In some cases, CO₂ may be a suitable gas, where the oxygen is more tightly bound to, e.g., oxygen in copper oxide. A forming gas, e.g., a mixture of an inert gas and hydrogen, can be used. Use of hydrogen alone at low pressures can be used.

Generally, cleaning using heat can be performed before, after, or instead of the roughening and/or etch steps. In addition to the embodiments of the attached claims and the embodiments described above, each of the embodiments of the following numbered paragraphs are also innovative.

Paragraph 1. A method of manufacturing a neutron generation target, the method comprising: (i) contacting a first surface of a lithium foil with a surface of a substrate; and (ii) applying a mechanical force to a second surface of the lithium foil that is opposite to the first surface of the lithium foil, thereby adhering the first surface of the lithium foil to the surface of the substrate to obtain the neutron generation target comprising a lithium layer on the surface of the substrate.

Paragraph 2. The method of paragraph 1, wherein the contacting is continuous.

Paragraph 3. The method of paragraphs 1 or 2, comprising roughening the surface of the substrate prior to contacting the first surface of a lithium foil with the surface of the substrate.

Paragraph 4. The method of any one of paragraphs 1-3, comprising etching the surface of the substrate.

Paragraph 5. The method of paragraph 4, wherein etching the surface of the substrate is carried out using an acid.

Paragraph 6. The method of paragraph 4, wherein etching the surface of the substrate is carried out by heating the substrate in the presence of hydrogen.

Paragraph 7. The method of any one of paragraphs 1-6, comprising removing contamination from the first surface of the lithium foil to expose lithium.

Paragraph 8. The method of any one of paragraphs 1-7, wherein the lithium foil comprises from about 92 percent by weight (wt. %) to about 98 wt. % of Li′ isotope.

Paragraph 9. The method of any one of paragraphs 1-8, wherein a thickness of the lithium foil is from about 15 micrometers (μm) to about 180 μm.

Paragraph 10. The method of paragraph 9, wherein thickness of the lithium foil is from about 90 μm to about 100 μm.

Paragraph 11. The method of any one of paragraphs 1-10, wherein thermal conductivity of the substrate is from about 300 W×m⁻¹×K⁻¹ to about 1000 W×m⁻¹×K⁻¹.

Paragraph 12. The method of any one of paragraphs 1-11, wherein the substrate consists essentially of copper.

Paragraph 13. The method of any one of paragraphs 1-11, wherein the substrate comprises diamond.

Paragraph 14. The method of any one of paragraphs 1-11, wherein the substrate comprises copper-diamond powder composites.

Paragraph 15. The method of any one of paragraphs 1-14, wherein the substrate is about 50 times, about 60 times, about 70 times, about 80 times, about 90 times, or about 100 times thicker than the lithium foil.

Paragraph 16. The method of any one of paragraphs 1-15, wherein the mechanical force is from about one megapascal (MPa) to about three MPa.

Paragraph 17. The method of paragraph 16, wherein the mechanical force is about two MPa.

Paragraph 18. A method of manufacturing a neutron generation target, the method comprising: (i) applying a material to a surface of a substrate to obtain a first layer on the surface of the substrate, wherein the material capable of forming an alloy with lithium metal or is otherwise capable of chemically or physically adhering to lithium metal; (ii) contacting the first layer and a first surface of a lithium foil; and (iii) applying a mechanical force to a second surface of the lithium foil that is opposite to the first surface of the lithium foil, thereby causing the first layer to adhere to the lithium foil to the substrate to obtain the neutron generation target comprising a lithium layer on the surface of the substrate.

Paragraph 19. The method of paragraph 18, wherein the contacting is continuous.

Paragraph 20. The method of paragraph 18, further comprising heating the neutron generation target while applying the mechanical force to facilitate diffusion and/or induce alloying between the material of the first layer and the lithium foil and/or vibrating the neutron generation target while applying the mechanical force to create friction between the first layer and the first surface of the lithium foil.

Paragraph 21. The method of paragraph 18, wherein the heating is performed at a temperature at or below about 180 degrees Celsius (° C.).

Paragraph 22. The method of paragraph 19, wherein the heating is performed at a temperature from about 100° C. to about 120° C.

Paragraph 23. The method of any one of paragraphs 18-22, comprising roughening the surface of the substrate prior to applying the material to the surface of the substrate.

Paragraph 24. The method of paragraph 23, wherein roughening the surface of the substrate comprises etching the surface of the substrate.

Paragraph 25. The method of paragraph 24, wherein etching the surface of the substrate is carried out using an acid.

Paragraph 26. The method of paragraph 24, wherein etching the surface of the substrate is carried out by heating the substrate in the presence of hydrogen.

Paragraph 27. The method of any one of paragraphs 18-26, comprising removing contamination from the first surface of the lithium foil to expose lithium.

Paragraph 28. The method of any one of paragraphs 18-27, wherein the lithium foil comprises from about 92 percent by weight (wt. %) to about 98 wt. % of Li′ isotope.

Paragraph 29. The method of any one of paragraphs 18-27, wherein thickness of the lithium foil is from about 15 micrometers (μm) to about 180 μm.

Paragraph 30. The method of paragraph 29, wherein thickness of the lithium foil is from about 90 μm to about 100 μm.

Paragraph 31. The method of any one of paragraphs 18-30, wherein thermal conductivity of the substrate is from about 300 W×m⁻¹×K⁻¹ to about 1000 W×m⁻¹×K⁻¹.

Paragraph 32. The method of any one of paragraphs 18-31, wherein the substrate consists essentially of copper.

Paragraph 33. The method of any one of paragraphs 18-31, wherein the substrate comprises diamond.

Paragraph 34. The method of any one of paragraphs 18-31, wherein the substrate comprises a copper-diamond powder composite.

Paragraph 35. The method of any one of paragraphs 18-34, wherein the substrate is about 50 times, about 60 times, about 70 times, about 80 times, about 90 times, or about 100 times thicker than the lithium foil.

Paragraph 36. The method of anyone of paragraphs 18-35, wherein the mechanical force is from about one megapascal (MPa) to about three MPa.

Paragraph 37. The method of paragraph 36, wherein the mechanical force is about two MPa.

Paragraph 38. The method of any one of paragraphs 18-37, wherein the material consists essentially of Al, Ag, Au, Zn, Bi, Pd, Si, SiO₂, SiO, Si₃N₄, C₃N₄, TiNSi, TiN, Cr, Ti, Ta, Mo, V, LiF, CrLiO₂, CrLi₂O₄, or CrLi₂O₂, or any combination thereof.

Paragraph 39. The method of paragraph 38, wherein the material consists essentially of aluminum.

Paragraph 40. The method of any one of paragraphs 18-39, wherein applying the material comprises performing a vapor deposition or a plasma deposition of the material on the surface of the substrate.

Paragraph 41. The method of paragraph 40, wherein the vapor deposition or the plasma deposition is carried out at atmospheric pressure.

Paragraph 42. The method of paragraph 40, wherein the vapor deposition or the plasma deposition is carried out under a vacuum.

Paragraph 43. The method of any one of paragraphs 18-42, wherein thickness of the first layer is from about 0.002 μm to about 1 μm.

Paragraph 44. The method of paragraph 43, wherein thickness of the first layer is about 0.1 μm.

Paragraph 45. The method of any one of paragraphs 18-44, wherein the material is capable of forming the alloy in the lithium layer and an amount of the material in the lithium layer of the neutron generation target is from about 0.5 wt. % to about 10 wt. %.

Paragraph 46. The method of any one of paragraphs 18-45, wherein neutron generation target is capable of producing a neutron yield that is not less than 90% of the neutron yield produced by a target prepared without the material capable of forming an alloy with lithium metal.

Paragraph 47. A combination of a lithium foil and a substrate for manufacturing a neutron generation target, the combination comprising: a substrate; a first layer of a material capable of forming an alloy with or otherwise capable to chemically or physically adhere to lithium metal positioned over the substrate; and a lithium foil; wherein a first surface of the lithium foil is in contact with the first layer.

Paragraph 48. The combination of paragraph 47, wherein the contact between the lithium foil and the first layer is continuous.

Paragraph 49. The combination of paragraph 48, wherein the lithium foil comprises from about 92 percent by weight (wt. %) to about 98 wt. % of Li⁷ isotope.

Paragraph 50. The combination of any one of paragraphs 47-49, wherein thickness of the lithium foil is from about 15 μm to about 180 μm.

Paragraph 51. The combination of paragraph 50, wherein thickness of the lithium foil is from about 90 μm to about 100 μm.

Paragraph 52. The combination of any one of paragraph 47-51, wherein thermal conductivity of the substrate is from about 300 W×m⁻¹×K⁻¹ to about 1000 W×m⁻¹×K⁻¹.

Paragraph 53. The combination of any one of paragraphs 47-52, wherein the substrate consists essentially of copper.

Paragraph 54. The combination of any one of paragraphs 47-52, wherein the substrate comprises diamond.

Paragraph 55. The combination of any one of paragraphs 47-52, wherein the substrate comprises a copper-diamond powder composite.

Paragraph 56. The combination of any one of paragraphs 47-55, wherein the substrate is about 50 times, about 60 times, about 70 times, about 80 times, about 90 times, or about 100 times thicker than the lithium foil.

Paragraph 57. The combination of any one of paragraphs 47-56, wherein the material consists essentially of Al, Ag, Au, Zn, Bi, Pd, Si, SiO₂, SiO, Si₃N₄, C₃N₄, TiNSi, TiN, TiWN, Cr, Ti, Ta, TaN, Mo, V, LiF, CrLiO₂, CrLi₂O₄, or CrLi₂O₂, or any combination thereof.

Paragraph 58. The combination of paragraph 57, wherein the material consist essentially of aluminum.

Paragraph 59. The combination of any one of paragraphs 47-58, wherein thickness of the first layer is from about 0.002 μm to about 1 μm.

Paragraph 60. The combination of paragraph 59, wherein thickness of the first layer is about 0.1 μm.

Paragraph 61. The combination of any one of paragraphs 47-60, wherein an amount of the material capable of forming an alloy with lithium metal in the combined amount of the first layer and the lithium foil is from about 0.1 wt. % to about 10 wt. %. Paragraph 62. The combination of paragraph 61, wherein the amount is from about 0.5 wt. % to about 1 wt. %.

Paragraph 63. A method of manufacturing a neutron generation target for boron neutron capture therapy, the method comprising: (i) applying lithium to a surface of a substrate to obtain a first layer of lithium on the surface of the substrate; (ii) contacting the first layer of lithium on the surface of the substrate and a first surface of a lithium foil to each other; and (iii) applying a mechanical force to a second surface of the lithium foil that is opposite to the first surface of the lithium foil sufficient to cause diffusion of lithium from the first layer into the lithium foil and adhere the lithium foil to the substrate to obtain the neutron generation target comprising a lithium layer on the surface of the substrate.

Paragraph 64. The method of paragraph 63, wherein the contact between the first layer of lithium and the first surface of the lithium foil is continuous.

Paragraph 65. The method of paragraph 63, further comprising heating the neutron generation target during the applying of the mechanical force to induce or facilitate diffusion between the first layer and the lithium foil and/or vibrating the neutron generation target during the applying of the mechanical force to create friction between the first layer of lithium and the first surface of the lithium foil.

Paragraph 66. The method of paragraph 65, wherein the heating comprises a temperature at or below about 180 degrees Celsius (° C.).

Paragraph 67. The method of paragraph 66, wherein the heating comprises a temperature from about 100° C. to about 120° C.

Paragraph 68. The method of any one of paragraphs 63-67, comprising roughening the surface of the substrate prior to applying lithium to the surface of the substrate.

Paragraph 69. The method of paragraph 68, comprising etching the surface of the substrate.

Paragraph 70. The method of paragraph 69, wherein etching the substrate surface is carried out using an acid.

Paragraph 71. The method of paragraph 69, wherein etching the surface of the substrate is carried out by heating the substrate in the presence of hydrogen.

Paragraph 72. The method of any one of paragraphs 63-71, comprising removing contamination from the first surface of the lithium foil to expose lithium.

Paragraph 73. The method of any one of paragraphs 63-72, wherein the lithium foil comprises from about 92 percent by weight (wt. %) to about 98 wt. % of Li′ isotope.

Paragraph 74. The method of any one of paragraphs 63-73, wherein thickness of the lithium foil is from about 15 micrometers (μm) to about 180 μm.

Paragraph 75. The method of any one of paragraphs 63-74, wherein thermal conductivity of the substrate is from about 300 W×m⁻¹×K⁻¹ to about 1000 W×m⁻¹×K⁻¹.

Paragraph 76. The method of any one of paragraphs 63-75, wherein the substrate comprises copper.

Paragraph 77. The method of any one of paragraphs 63-75, wherein the substrate comprises diamond.

Paragraph 78. The method of any one of paragraphs 63-75, wherein the substrate comprises copper-diamond powder composites.

Paragraph 79. The method of any one of paragraphs 63-78, wherein the substrate is about 50 times, about 60 times, about 70 times, about 80 times, about 90 times, or about 100 times thicker than the lithium foil.

Paragraph 80. The method of any one of paragraphs 63-79, wherein the mechanical force is from about one megapascal (MPa) to about three MPa.

Paragraph 81. The method of paragraph 80, wherein the mechanical force is about two MPa.

Paragraph 82. The method of any one of paragraphs 63-81, wherein applying lithium to the surface of the substrate to obtain the first layer of lithium on the surface of the substrate comprises vapor deposition or a plasma deposition of lithium on the surface of the substrate.

Paragraph 83 The method of paragraph 82, wherein the vapor deposition or the plasma deposition is carried out at atmospheric pressure.

Paragraph 84. The method of paragraph 82, wherein the vapor deposition or the plasma deposition is carried out under a vacuum.

Paragraph 85. The method of any one of paragraphs 63-84, wherein thickness of the first layer is from about 0.01 μm to about 0.3 μm.

Paragraph 86. The method of paragraph 85, wherein thickness of the first layer is about 0.1 μm.

Paragraph 87. The method of paragraph 1 or 2, wherein the first surface of the lithium foil is contacted with the surface of the substrate such that 99% or greater of the macroscopic area of the first surface of the lithium foil is in contact with a corresponding amount of the area of the surface of the substrate.

Paragraph 88. The method of paragraph 18 or 19, wherein the first surface of the lithium foil is contacted with the first layer such that 99% or greater of the macroscopic area of the first surface of the lithium foil is in contact with a corresponding amount of the area of the surface of the substrate.

Paragraph 89. The combination of paragraph 47 or 48, wherein 99% or greater of the macroscopic area of the first surface of the lithium foil is in contact with a corresponding amount of the area of the surface of the substrate.

Paragraph 90. The method of paragraph 63 or 64, wherein the first surface of the lithium foil is contacted with the first layer of lithium such that 99% or greater of the macroscopic area of the first surface of the lithium foil is in contact with the first layer of lithium.

### OTHER EMBODIMENTS

It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise.

1. A method of manufacturing a neutron generation target, the method comprising:
(i) contacting a first surface of a lithium foil with a surface of a substrate; and
(ii) applying a mechanical force to a second surface of the lithium foil that is opposite to the first surface of the lithium foil, thereby adhering the first surface of the lithium foil to the surface of the substrate to obtain the neutron generation target comprising a lithium layer on the surface of the substrate.

2. The method of claim 1, wherein the contacting is continuous.

3. The method of claim 1, comprising roughening the surface of the substrate prior to contacting the first surface of a lithium foil with the surface of the substrate.

4. The method of claim 1, comprising etching the surface of the substrate.

5. The method of claim 4, wherein etching the surface of the substrate is carried out using an acid.

6. The method of claim 4, wherein etching the surface of the substrate is carried out by heating the substrate in the presence of hydrogen.

7. The method of claim 1, comprising removing contamination from the first surface of the lithium foil to expose lithium.

8. The method of claim 1, wherein the lithium foil comprises from about 92 percent by weight (wt. %) to about 98 wt. % of Li⁷ isotope.

9. The method of claim 1, wherein a thickness of the lithium foil is from about 15 micrometers (μm) to about 180 μm.

10. The method of claim 9, wherein thickness of the lithium foil is from about 90 μm to about 100 μm.

11. The method of claim 1, wherein thermal conductivity of the substrate is from about 300 W×m⁻¹×K⁻¹ to about 1000 W×m⁻¹×K⁻¹.

12. The method of claim 1, wherein the substrate consists essentially of copper.

13. The method of claim 1, wherein the substrate comprises diamond.

14. The method of claim 1, wherein the substrate comprises copper-diamond powder composites.

15. The method of claim 1, wherein the substrate is about 50 times, about 60 times, about 70 times, about 80 times, about 90 times, or about 100 times thicker than the lithium foil.

16. The method of claim 1, wherein the mechanical force is from about one megapascal (MPa) to about three MPa.

17. The method of claim 16, wherein the mechanical force is about two MPa.

18. A method of manufacturing a neutron generation target, the method comprising:
(i) applying a material to a surface of a substrate to obtain a first layer on the surface of the substrate, wherein the material is capable of forming an alloy with lithium metal or is otherwise capable of chemically or physically adhering to lithium metal;
(ii) contacting the first layer and a first surface of a lithium foil; and
(iii) applying a mechanical force to a second surface of the lithium foil that is opposite to the first surface of the lithium foil, thereby causing the first layer to adhere to the lithium foil to the substrate to obtain the neutron generation target comprising a lithium layer on the surface of the substrate.

19. The method of claim 18, wherein the contacting is continuous.

20. The method of claim 18, further comprising heating the neutron generation target in while applying the mechanical force to facilitate diffusion and/or induce alloying between the material of the first layer and the lithium foil and/or vibrating the neutron generation target while applying the mechanical force to create friction between the first layer and the first surface of the lithium foil.

21-90. (canceled)
